(19) United States
(12) Patent Application Publication
(10) Pub. No.: US 2002/0075332 A1
(43) Pub. Date: Jun. 20, 2002

(54) SYSTEMS AND METHODS FOR INTERACTIVE PRODUCT PLACEMENT

(76) Inventors: BRADLEY EARL GEILFUSS JR., BEDFORD, MA (US); VICTOR OWUOR, CAMBRIDGE, MA (US); ESSAM ERNEST ABADIR, NEW YORK, NY (US)

Correspondence Address: FISH & RICHARDSON P.C., 225 FRANKLIN STREET, BOSTON, MA, 02110-2804, US

(21) Appl. No.: 09/401,394

(22) Filed: Sep. 22, 1999

(51) Int. Cl. G09G 5/00

(52) U.S. Cl. 345/859

(57) ABSTRACT

The present invention provides methods for making static content active and for indicating active areas to users from a distance. A method in accordance with the invention indicates the location of one or more selectable-links by indicating on a display the location of a selectable-link when a selector is positioned within a predetermined range outside of any selectable-link. In further respects, this method can have the indicated selectable-link hidden from the display when the selector is positioned beyond the predetermined range of the selectable-link, and can maintain the indication throughout the movement of the selector within the predetermined range. Another method indicates the location of one or more elements of additional information associated with an image. This method includes the step of indicating on a display the location of the additional information when a selector is positioned within a predetermined range outside of any active region. As in the previous method, in further respects the location of the additional information can be hidden from the display when the selector is positioned beyond the predetermined range of the active region, and can maintain the indication throughout the movement of the selector within the predetermined range. Related systems are also disclosed.

### FIELD OF THE INVENTION

The present invention relates to a system and method for transforming existing content (for example, a graphical image or streamed video) into interactive content for presentation on a Web page. The present invention also relates to a system and method for providing interactive product placements. In further aspects, the present invention defines distinct e-commerce markets that are responsive to the interactive content. One e-commerce market is a new source of advertising revenue which permits advertisers to rent space within the existing content by providing users with further information about their products for a fee. Another e-commerce market defined by the present invention is a direct sale market wherein revenue can be derived from sales of products and services relating to the interactive content.

### BACKGROUND

The concept of product placement has enjoyed success in traditional media such as television and movies. Product placement refers to the use or appearance of a brand name product in its ordinary context within a scene or picture. Depending on its ordinary use, the product is driven, consumed, or visible in the depicted scene. This form of advertising is subtle, as viewers are not confronted with an explicit or overt advertisement but rather the product simply appears in context and sometimes in use by the actors. There are limitations associated with product placement advertising that has been used on the Web and in traditional media so far, including the lack of interactivity with the user and the inability to conduct a purchase transaction.

At present, the Internet is the fastest growing market for conducting business, known as “e-commerce.” A significant obstacle to e-commerce has been the cost and time required to develop and place online Web sites that support purchase transactions on the Internet and other networks. Another obstacle has been the form and presentation of Web sites themselves, which must be current and attract users' attentions.

A problem experienced by many is that the time required to publish information online results in Web sites lagging other media forms. Compounding the problem is the fact that the effort, time and money spent on producing content for printed media such as catalogs and advertisements is often set aside in favor of comparatively lackluster presentations for the Web page. A majority of offline content has not been put online because it is unappealing when in online form, and, therefore, remains underutilized.

A popular approach taken by many e-commerce Web sites is to arrange products by category in a tree structure. Such an arrangement requires the user to first select from among several broad categories such as clothing, appliances, and furniture. At the next level, the user selects more specific categories such as shirts or swim wear from the clothing category or refrigerators or ovens from the appliance category. The user continues in this fashion, loading page after page into his or her Web browser or other display, until the product of choice is displayed. At that point, the user typically can add the item to his or her metaphorical “shopping cart” and then parse different portions of the Web site until ready to pay for the selected items. This approach to Web design and the manner of enticing a user to select an item for purchase differ dramatically from the presentation in catalogs and other print media, for example.

What is needed in the art and has heretofore not been available is a system and method for transforming and leveraging existing content into interactive content for presentation on a Web site. What is further needed in the art is such a system and method in which revenues are generated from the transformed content in response to the interactions of a user with the content. Of further benefit would be a system and method which tracks both mouse movements and mouse activity at the client-side of a global network so that data can be gathered on the interests and user-responses to particular elements in a Web page. The present invention satisfies these and other needs.

### SUMMARY OF THE INVENTION

The present invention provides systems and techniques for harnessing existing, static content as a new platform for electronic commerce transactions. The invention provides techniques for making static content active, and highlighting such active areas. In further aspects, a new revenue model results which facilitates electronic commerce by allowing content providers to provide value-added functionality to their viewers without being burdened by handling electronic commerce transactions or merchandise.

In accordance with one aspect of the invention, an electronic commerce method is disclosed in which revenue is generated from a Web page of a content provider. In this method, a Web page is constructed and conveyed to a client-side browser in response to a request to load the Web page of the content provider. The Web page is constructed so as to include an activated image from a host server within an HTML document of the content provider. The so constructed Web page is then conveyed to the client side browser. A host server then receives a request from the client-side browser in response to an interaction with the activated image. The request is forwarded from the host server to a prescribed third-party for fulfillment. Thereafter, the third-party is charged for the forwarded request. In further features of this aspect of the invention, the content provider can be credited for providing a forum in which such a request can be received and processed.

In another aspect of the invention, a method for deriving revenue from placed products within Web pages includes the steps of displaying an interactive placed product within a Web page on a display, responding to a user-driven event associated with the placed product by displaying further information concerning the placed product, and charging a source of the product for the user-driven event. The information can comprise an advertisement or a purchase form.

In yet another aspect of the present invention, a method is provided for indicating a location of one or more selectable-links. This method includes the step of indicating on a display the location of a selectable-link when a selector is positioned within a predetermined range outside of any selectable-link. In further respects, this method can have the indicated selectable-link hidden from the display when the selector is positioned beyond the predetermined range of the selectable-link, and can maintain the indication throughout the movement of the selector within the predetermined range.

In a related aspect of the present invention, a method is provided for indicating a location of one or more elements of additional information associated with an image. This method includes the step of indicating on a display the location of the additional information when a selector is positioned within a predetermined range outside of any active region. As in the previous method, in further respects the location of the additional information can be hidden from the display when the selector is positioned beyond the predetermined range of the active region, and can maintain the indication throughout the movement of the selector within the predetermined range.

In still another aspect of the present invention, a method is provided for interactively displaying information to a user. The method includes the steps of displaying a first image which has one or more active regions associated with it and obscuring a portion of the first image with a second image fragment in response to a user's interaction with the active regions. Preferably, the second image fragment is a different depiction of the obscured portion of first image.

In a related aspect, the invention provides a system for selectively indicating a location of one or more elements on the display of a terminal. The system includes a cursor on the display of the type which is repositionable by a user, for example, in response to movement of a selector or interaction with a touch-sensitive display. The system also includes a proximity detector which is operational within the terminal and responsive to the position of the cursor to selectively identify the location of the element only when the cursor is positioned within a predetermined region within and clear of the element.

These and other aspects and features of the present invention can be better appreciated from the accompanying figures and the following written description.

### BRIEF DESCRIPTION OF THE DRAWINGS

FIG. 1 illustrates a process flow for defining an interactive image for a Web page in accordance with one feature of the present invention;

FIG. 2 is a digital image which illustrates a scene;

FIGS. 3A-D are various alternate images or templates with active regions for superimposing with the digital image of FIG. 2;

FIG. 4 illustrates a network configuration that may be used with the present invention;

FIG. 5a illustrates a process flow that executes when a client addresses a particular page at a content provider's Web site to optimize interactions with the interactive images;

FIG. 5b illustrates a process flow for tracking mouse movements and selections and processing interactive events between a user and an activated image in accordance with another feature of the present invention;

FIG. 6 illustrates a cursor positioned over the image of FIG. 2, with the location of a selectable-link being divulged by the superimposed display of a portion of FIG. 3;

FIG. 7 is a flow diagram illustrating in detail the recording of user and system events in the activated image; and

FIG. 8 is an information flow diagram between a host, a content provider 412, and an individual at a client-side station.

### DETAILED DESCRIPTION

By way of overview and introduction, one or more products that appear in existing content on a particular Web page are made interactive so that the user can obtain further information related to the product and perhaps purchase it through his or her Web browser. Such further information and purchase options can be made at that particular site rather than having to link over to the site of the manufacturer or merchant.

In one embodiment, the invention permits catalogers, publishers and others to rapidly generate interactive Web pages which support e-commerce without the need for their own back-end transaction processing system or complex Web programming. Interactive Web pages are generated directly from their existing content by making one or more regions in or associated with the image responsive to user-driven events such as mouse movements and button clicks. The response to such user driven events may include revealing product information or providing the user with the opportunity to purchase wares or services.

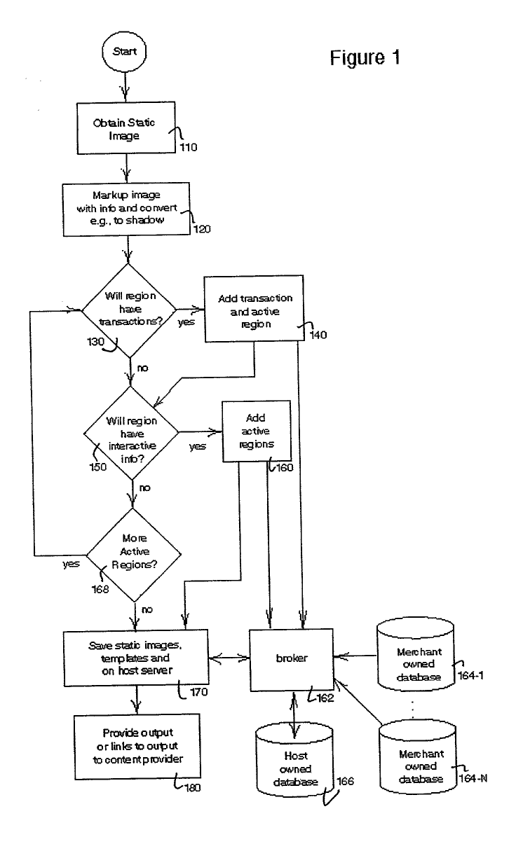

With reference now to FIGS. 1-3, a process is described for creating a Web page in which static content is transformed to include interactive placed products. The process 100 can be done by an application program interface (API) which permits even a modestly experienced programmer to transform a static image into an interactive image with pop-up content, forms, and/or animation. Such an API uses a meta language, entered by the programmer, which is translated into code by a parsing engine. Alternatively, a more robust API can be provided which includes further automation and functionality to permit a layperson with no knowledge or experience in Web page design to transform a static image into an interactive one.

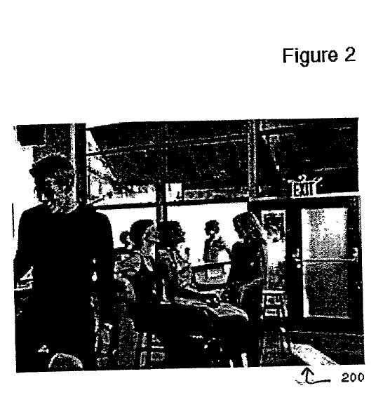

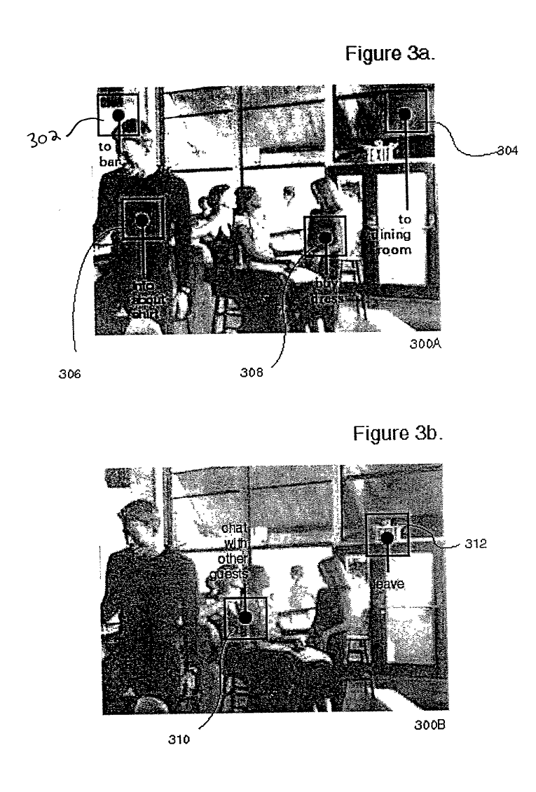

The transformation process begins at step 110 by obtaining a static image in digital form, such as the image 200 in FIG. 2. The image can be a digitally captured image from a digital camera (direct digital capture) or from a scanner (indirect digital capture). The process of capturing the static image and its source are not material to the present invention. The obtained image is manipulated by a computer operator under control of the API at step 120 so as to define one or more separate markup images or templates having information relating to the captured image 200. For example, the markup image may be a shadow of the image 200, such as the image or templates 300A and 300B shown in FIGS. 3A and 3B, respectively (more generally, templates 300). Any given template 300 can be an image derived from the image 200, as shown in FIG. 3C, or can be a transparent GIF (or other format) as shown in FIG. 3D. FIGS. 3A and 3B show two different grey-scale (“shadow”) templates, each with different active regions as described below. Among other possible forms for the template 300 are a reduced resolution image (produced by a pixel subtraction process as understood by those of skill in the art), a reduced hue image, or an optical negative of the image 200. A reduced resolution image contains fewer pixels per unit of area than a higher resolution image and a reduced hue image contains fewer gradations of color than a higher hue image. In this manner, the image 200 is unadulterated and is not itself an anchored image and does not itself define an image map. In other words, the resulting activated image maintains its original aesthetic integrity, yet enables electronic commerce and other forms of interaction with the user to add value to a content provider.

One or more active regions can be associated with the captured image 200 through the templates 300 and stored in a definition file which is called upon each time an activated-image is loaded. At step 130, the API responds to any user requests to add transactions to a template 300 by adding active regions of that type (transaction) to the template, as at step 140, with which the user can interact. The API also responds to any user requests to add information to the template 300 at step 150 by adding active regions at step 160 with which the user can interact to identify further information about an element within the image 200. Each active region is mapped relative to the templates 300 so that the captured image 200 remains unadulterated. The template or images that are active or in use at any given time may vary with the profile data of the user, the time of day, previously visited sites, advertisement schedules, or another predetermined criterion contained in the definition file.

Each of the active regions can provide a unique response when the user interacts with such regions. The nature of the response is defined by the computer operator at steps 140 and 160. The response can include swapping, layering or otherwise displaying another image on the user's Web browser (which is the response provided by links 302 and 304 of the template 300A or link 312 of template 300B), enabling a chat with other persons who are accessing the content provider's Web site (which is the response of link 310), playing a music or audio clip, and presenting a fully enabled e-commerce transaction processing form by which the user can purchase an item related to that active region (e.g., the response provided by links 306 and 308). The manner by which an individual interacts with the active regions and the user-driven events in response to such interaction are described below. Fewer or additional active regions can be associated with any given image 200 through the templates 300.

The definition of an active region includes the identity the items in the static image which are to be made interactive along with any further information to be displayed, the manner in which it is to be displayed, and other details if the item is purchasable. For example, if the image is a shot of fashion swim wear and one swim suit is to be purchasable by interacting with the image 200, the following would be identified: that such item is to be made interactive; whether any further information is to be displayed and, if so, the content and form of that information, and whether it is to be presented in a separate browser window or as an image in the active window. This information is generally constant from one page load to the next. However, the file is updateable dynamically and various pieces of information such as the identity of any merchant that is relied upon to provide goods or services and/or any brand that wants to advertise their goods and services can be changed with each page load.

The determination of which merchant or advertiser to include in a definition file, once a page is to be loaded at a client-side browser, is made by a broker 162. The broker manages the contents of the definition file to be sent in response to the page load request, for example, the broker determines which merchant or advertiser to include in the definition file. The broker 162 contains business rules (logic) which queries merchants as to the quantity of an item in stock from a particular source, pricing, and the availability of substitute items to select and then makes a merchant/advertiser selection. Once a merchant/advertiser is selected, the relevant data (which will enable the interactive event at the active region being defined by the operator) is imported from the merchant's own database 164. Plural merchants 164-1, . . . 164-N make portions of their data available to the broker to facilitate and inform this decision. The decision and other data are then stored in a host database 166, which is also accessed by the broker 162 for further data such as customer complaints concerning particular merchants, frequency of the selection of a particular merchant, delivery times associated with particular merchants with which the host has dealt, and the like. As understood by those of skill in the art, the definition file may itself reference or link to other sites or information sources for additional and/or updated information concerning, merchants, quantities in stock, prices, and other data.

Importantly, multiple products in the graphical image 200 can be purchased from that Web page even if the products are from different sources. In this regard, the present invention provides an aggregation of different products from different sources, yet presents a single purchase transaction to the customer. From the customer's perspective, he or she does not have to navigate to a commercial site, switch to a different site, or download additional pages. Rather, the customer is presented with an enhanced Web experience at a site of choice, such as an online magazine.

Referring again to FIG. 1, the user marks regions associated with the image 200 until all active regions have been defined. The definition of each active region, including the manner of that region's response, its location and size, the range away from which its presence is to be indicated, and any data or source of data concerning the merchant relied upon to provide goods or services or the brand that wishes to advertise its goods and services are stored in a definition file (a “.lqd” file) for the image 200. The definition file is a text file that is parsed in realtime at the client-side browser using image-activation software (described below) and has its contents merged with the content of the content provider. An exemplary definition file, in pseudocode with comments, is as follows:

Sample Definition File

SAMPLE DEFINITION FILE
//Define Pictures
//the main picture is the color picture
var main = AddPictureToScreen(“mainpicture”, 200, 200, “mypicture.jpg”) //places an activatable image at position
200, 200 in the screen coordinate system.
//portions of the shadow picture can be displayed by the searchlight routine, described below. The shadow picture is
shown to indicate active regions in the main picture
Var shadow = AddPictureToScreen(“shadowpicture”, 200, 200, “myshadow.jpg”) //displays the template (here, a
shadow picture) at position 200, 200 in the screen coordinate system.
//add a transaction to the template (e.g., to the shadow picture)
AddAreaToPicture(“buyshirt”, shadow, “200,200,50,50”, “window.open(‘infoOnShirt.html’)“) //add the info on
shirt area to the shadow
// Attach searchlight effect to picture when mouse moves over the main picture
AttachMouseMoveHandlerToPicture(main, “searchLight(‘pictureshadow’, −50,−1000, 50,1000”)”)
// Attach searchlight effect to picture shadow when mouse moves over the shadow picture
AttachMouseMoveHandlerToPicture(main, “searchLight(‘pictureshadow’, −50,−1000, 50,1000”)”)

In the definition file above, “mypicturejpg” corresponds to the image 200 and “myshadowjpg” corresponds to the template 300. The functions “AddPictureToScreen,” “AddAreaToPicture,” “AttachMouseMoveHandlerToPicture,” and “searchLight” are defined by image-activation software that is preferably loaded by (or contained within) a header, described below. The active regions are defined in “AddAreaToPicture” objects, and include the location and size of the active region within a particular template (e.g., “shadow”). Other objects can be defined in the definition file to handle particular events such as the searchlight event handler “searchLight,” which is triggered in the main picture, maintained in the template, and attached to both “images” so that the searchlight effect is continuous and fluid in character.

Once all desired active regions have been defined for a given template, the operator can elect to create additional templates at step 168 by looping back to step 120. Otherwise, the images 200 and templates 300 are saved at step 170. The saved images or links to the images are output to the server of a content provider at step 180.

The present invention in no way requires any particular location for the images 200, 300 or definition file to be maintained or even defined. A static image 200 is transformed into an interactive one by including at the server-side any templates 300 and definition file into HTML content of the content provider and then providing the resultant Web pages to a client-side browser. The image 200, template(s) 300, and definition file together comprise an “activated” or “liquid” image which responds or flows with the actions of the user. Using HTML include file tags, content providers can format and arrange their Web pages and their entire Web site in any manner, and make their site more interactive by substituting static images 200 for activated images in the same space. For example, the image can occupy a defined region on a Web page or a frame in a frameset. The frameset can include a series of images 200, each with associated templates 300 and definition files so as to constitute an interactive, online catalog.

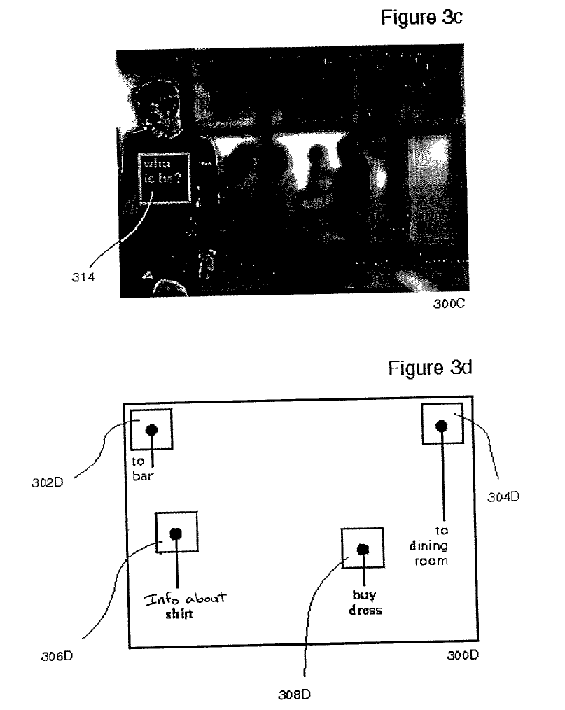

With reference now to FIG. 4, a network configuration 400 that may be used to implement the systems and methods of the present invention is illustrated. The hardware components are conventional and form no part of the present invention. A host system 402 comprises a Web server such as a Microsoft IIS 3.0 or 4.0 server or a Netscape Enterprise server and includes software, databases, and files necessary to implement and run the system and methods of the present invention. The host system 400 includes a connection to a global or other network, such as the Internet 404. Also connected to the Internet are a plurality of merchants 406, 408 (only two shown).

An individual 410 can directly access these merchants 406, 408 through the Internet using a Web browser or similar program or application. Indeed, this is ordinarily what the individual would do were he or she shopping for goods or services made available by these merchants. However, in accordance with an aspect of the invention, the individual 410 can interact with these merchants, be provided with further information concerning their goods and services, and also have the opportunity to make purchases from them without ever addressing or loading the merchants' respective Web pages. Instead, these merchants can provide such information and avail themselves of further opportunities to make sales through the active regions 302-308 associated with the content of third parties (e.g. content provider 412). For example, a static image 200 of a third party content provider 412 ordinarily is presented when its Web page is addressed. A merchant can arrange with the content provider to have particular regions of the image 200 made active to provide visitors with interactivity which may be of value to the visitor and which may increase the “stickiness” of the content provider's Web site (i.e., increase the time a visitor stays at that Web site rather than linking to another site). The interactivity is provided by substituting the activated image from the host system 402 for the static image 200, along with active-image player software and a definition file. The substituted active image occupies the same space (“real estate”) on the content provider's Web site as did the original, static content. Any interactivity with the activated image within the boundaries of the designated real estate can be managed by a program running at the content provider's server or at the host system 402. Thus, for example, the clicks and movements of a user's selector (e.g., mouse) can be tracked and any interaction with an active region in that space can be handled by such server, that is, the designated manager.

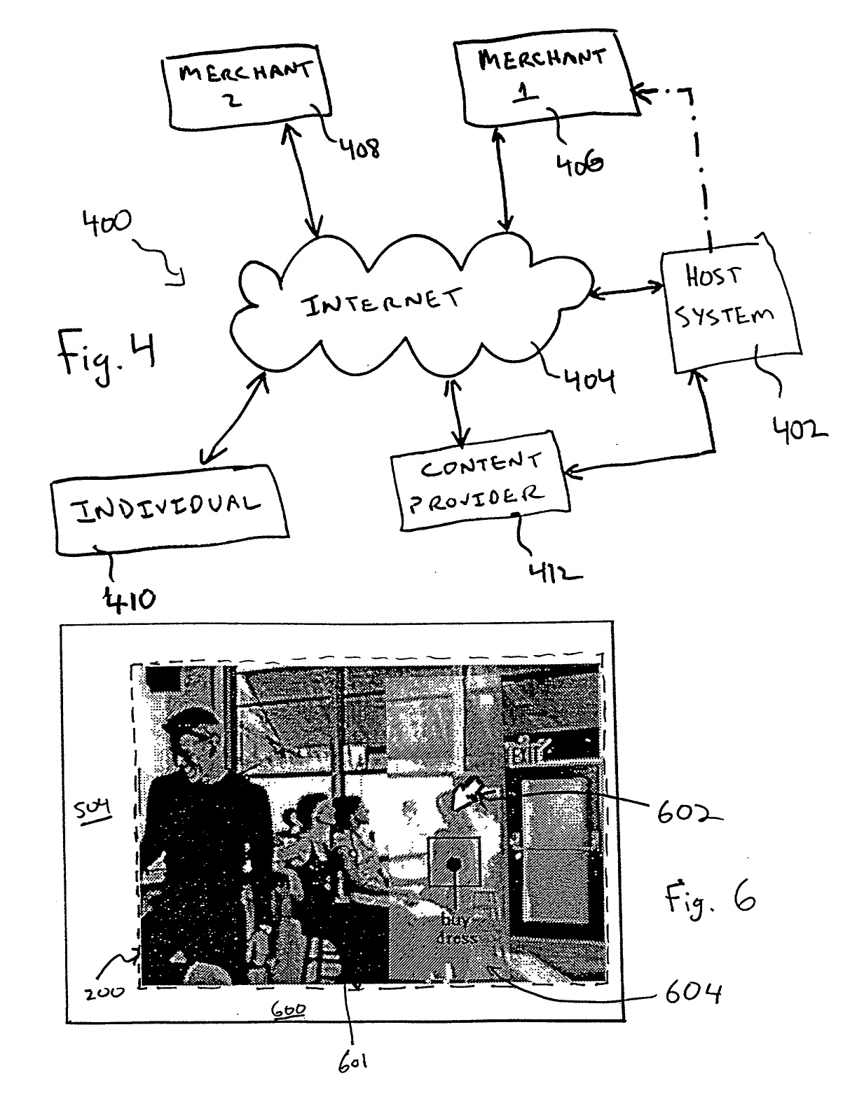

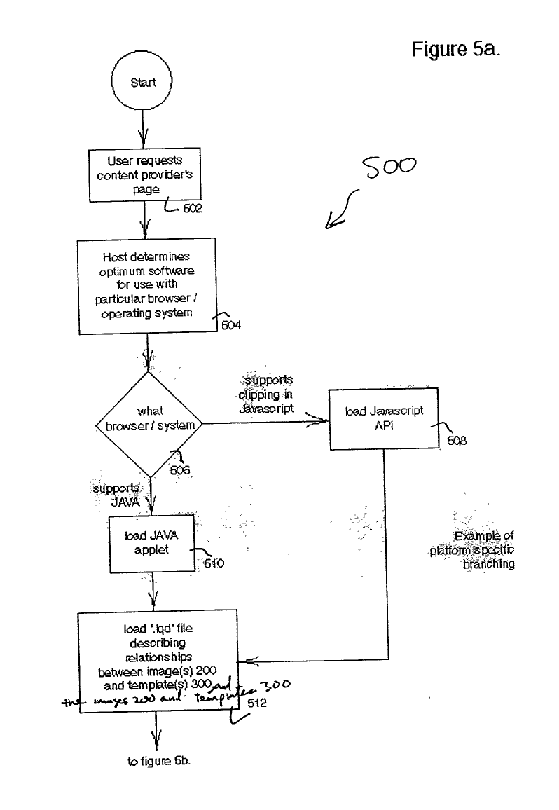

FIGS. 5a and 5b describe a process flow 500 of the interactions between a user and one or more active regions in the activated image.

The flow starts at step 502 of FIG. 5a with the user requesting a Web page from a content provider, such as the content provider 412. This is done, for example, by entering the URL of the content provider in the address box of a Web browser or by clicking a bookmark or hypertext link from another Web page. Prior to displaying the content provider's Web page, the request is communicated back to the host which determines at step 504 which version of the image-activation software (“player”) is best for use with the particular browser or operating system of the user, that is, at the client side. Alternatively, a client-side test can be made to determine the type of browser and operating system that the individual is using and then reference the host system directly for the appropriate player. The image-activation player permits the definition file to be parsed at the client-side and includes functions and objects which manage any user-initiated or system-state change events, as described below. Preferably, the configuration at the client-side browser is discerned by a header script which runs at the content provider's Web server. The header script determines which software to load by a process generally known as platform-specific branching. A sample Web page of the content provider includes such a header and can be implemented as generally indicated in the pseudocode below.

Sample Web Page Which Loads Header and Definition File

<%@ Language=VBScript %>
<HTML>
<HEAD>
<!--#include file =“header.htm”-->
<SCRIPT LANGUAGE=“javascript1.2”>

function mywindowload() {
<!--#include file =“mylqd.lqd”-->}

</SCRIPT>
</HEAD>
<BODY onload=“return mywindowload()” BGCOLOR =“#000000”
TEXT =“#FFFFFF” LINK = “#FFFFFF” VLINK = “#FFFFFF”>
//Content provider's content goes here, including images, buttons, frames,
forms, and formatted text.
<P>&nbsp;</P>
<!-- #include file =”mylqd.img” -- >
</BODY>
</HTML>

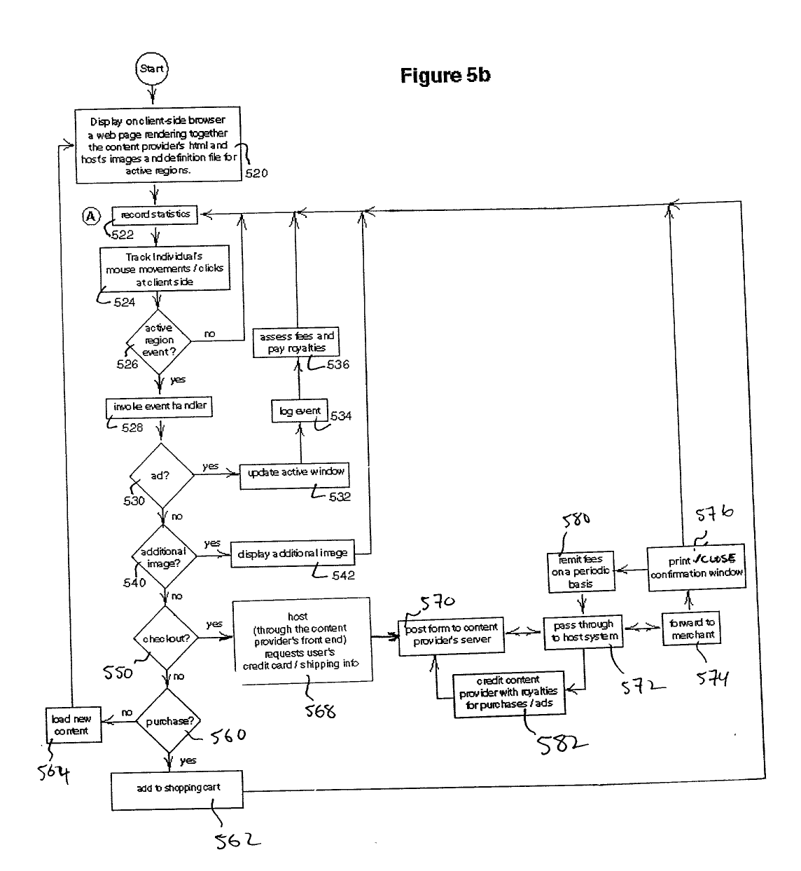

The sample Web page includes a file “header.htm” and causes the definition file “mylqd.lqd” to be loaded upon loading the content provider's Web page. The definition file, as described above, causes the main image 200 to load as well as the templates 300 and all of the objects and functions that are associated with the image 200 such as navigation (see buttons 302 and 304), advertisements (button 306), e-commerce transaction support (button 308), and any other visual techniques that are used to make the image 200 more interesting (such as system-initiated or user-responsive scaling, scrolling, or distorting routines). The file “header.htm” performs the platform-specific branching functions and also causes the image-activation software (“player”) to load. The file “mylqd.img” replaces the HTML image tag for the static image provided by the content provider thereby rendering an activated image in the real estate that would otherwise be utilized by the content provider's static image. Once the server-side include tags and/or other code are processed, a resulting Web page 600 is conveyed to the individual at his or her machine 304, as shown in FIG. 6. The Web page 600 includes real estate 601 which has been rendered or constructed to include an activated image in accordance with the present invention instead of simply displaying the static image 200.

The player includes objects and functions necessary to implement the functionality called for in a particular definition file, and the complexity of the player can be varied to suit the needs of a particular application. The following is a sample player, in pseudocode, which is suitable for handling the active regions and searchlight feature of the sample definition file above.

Sample Image-activation Software or Player

function AddPictureToScreen (picturename, positionX, positionY, graphicname){

| var mypicture = new Layer () | // create DHTML layer which holds the graphic |
|---|---|
| var HTMLforPicture = “<IMG src=” + grphicname + “>” | |
| HTMLforPicture = HTMLforPicture + ‘<map name=“‘ + name + ’map”>’; | |
| mypicture.HTMLforPicture = HTMLforPicture | |
| mypicture.name = picturename | // assign name to layer for later referencing |
| mypicture.moveTo(positionX, positionY) | // position layer to coordinates provided in function |
| | call. |
| mypicture.document.open() | //open layer to add the HTML with the graphic to it |
| mypicture.document.write1n (HTMLforPicture) | //write HTML to the layer |
| mypicture.document.close() //close the layer | |
| return mypicture;} | |

function AddAreaToPicture(name, pictureobj, coords, onclickscript){

| | |
|---|---|
| this.name = name; | |
| this.coords = coords; | //the coordinates for the selectable area |
| this.onclick = onclickscript; | //the script invoked upon selecting the area |
| var mystring; | //define an HTML string concerning the area |
| mystring = ‘<AREA NAME’”; | |
| mystring += this.name; | |
| mystring += “‘SHAPE=RECT’”; | |
| mystring += this.shape ; | |
| mystring += “‘COORDS=’”; | |
| mystring += this.coords ; | |

mystring += “‘HREF=”” onclick=’ + this.onclick’;

| mystring += this.onmouseover; | | |
|---|---|---|
| mystring += “‘onmouseout=’”; | | |
| mystring += this.onmouseout; | | |
| mystring += “‘ >’; | | |
| return mystring; | | |
| | | //add area to the other HTML for the picture |
| pictureobj.document.open() | | //open picture to add HTML and graphic |
| | pictureobj.document.writeln (pictureobj.HTMLforPicture + mystring) //write the HTML to the layer | |
| | pictureobj.document.close() | //close the picture |

pictureobj.HTMLforPicture = pictureobj.HTMLforPicture + mystring;}

AttachMouseMoveHandlerToPicture(picturehavingeventattached, effectcodestring){

| picturehavingeventattached.onmousemove = function (effectcodestring) { | |
|---|---|
| window.captureevents (“mouseout”); | |
| eval (effectcodestring)}; | //when selector moves over the picture having an |
| | event attached to it, the string of code is evaluated. |
| | E.g. the string of code might specify |
| | “searchLight(‘myshadow’, −50,−100,50,100)” |

}
function searchLight(picturename, dleft, dtop, dright, dbottom) {

| | |
|---|---|
| var event_clientX; | |
| var event_clientY; | |
| event_clientX = myevent.pageX | |
| event_clientY = myevent.pageY | |
| var mytop = document.layers[picturename].top; | |
| var myleft = document.layers[picturename].left; | |
| var top = event_clientY + dtop − myleft; | |
| var left = event_clientX + dleft − myleft; | |
| var right = event_clientX + dright − myleft; | |
| var bottom = event_clientY + dbottom − mytop; | |
| | //modify picture to the new viewable “clip region” |
| | and only clip to a region where the image exists. |

document.layers[picturename].clip.top = (top < 0) ? 0 : top;
document.layers[picturename].clip.left = (left < 0) ? 0 : left;
document.layers[picturename].clip.right = (right < 0) ? 0 : right;
document.layers[picturename].clip.bottom = (bottom < 0) ? 0 : bottom;}

The functions and objects in the player operate as follows. The function AddPictureToScreen( ) places an image on the screen at the predetermined X, Y coordinates specified. For example, the image 200 and the template(s) 300 are positioned on the browser screen using the AddPictureToScreen( ) function. The function AddAreaToPicture( ) allows active regions to be included in the picture(s) previously added to the screen. The active regions are included the picture at an X,Y coordinate relative to the coordinates of the picture. The function AttachMouseMoveEventHandlerToPicture( ) attaches a handler function which is invoked whenever the selector (e.g., mouse) is moved over a specified picture which was previously added using the AddPictureToScreen( ) function. Finally, the function searchLigh( ) exemplifies the type of function that can be added to handle the event of a selector being positioned over a specified picture and that can be attached to the event via the AttachMouseMoveHanderToPicture( ) function. In this case, the searchLight( ) function detects the location of the user's selector and crops the specified picture a certain distance from the left, top, right, or bottom of the selector's position (variables dleft, dtop, dright, dbottom in the pseudocode above).

Returning back to FIG. 5a, there are many ways to perform platform-specific branching including active server pages, CGI routines, Cold Fusion, PHP, and others; the particular approach to be used is specific to the Web server being used. At step 506, one of these known methods for testing the type and version of the user's operating system and browser is implemented. If the user's browser/operating system supports clipping and other necessary operations in Javascript, then a Javascript player is loaded at step 508. Otherwise, a program written in another language supported by the browser such as Java or Macromedia's Lingo for Shockwave is loaded at step 510 (for simplicity only Java is depicted in step 510). Thereafter, the activated image including the image 200, template(s) 300, and definition file is loaded at step 512. Other images and scripts can also be loaded and cached for later display, for displaying further information, or for client-side activity processing.

The scripts that are pre-loaded can be used to track the movements of the individual's mouse, as well as its clicks and dwell time in certain positions within the real estate 601. Such tracking can be accomplished by a scripted loop which periodically, and/or when a mouse button is pressed, records mouse coordinates in an array, for example. The tracking routine may further record rapid changes in position, or may sample the mouse movements more frequently when the Web page is first displayed to record the individual's initial reaction. The tracking function operates at the client-side and generates volumes of information concerning individual's reaction to various elements in the activated image, whether in a defined active region or not. A separate function or script can be used to compress or filter the recorded data in accordance with predetermined criteria. Such tracking represents a departure from prior art techniques of monitoring mouse movements because the client-side activity is monitored between hypertext transfer protocol (“http”) requests by the user and thereby provides a clearer “view” as to what the individual did while the activated image was being displayed. Known prior tracking technologies, in contrast, have culled data concerning which sites a user has visited and for how long, but have not tracked intermediate events such where the mouse was positioned within an image, and which icons or regions were passed over by the mouse. However, content providers are very interested in knowing this information about a user, but are not able to “see over the user's shoulder.” The recorded data is reportable to a designated server such as the host system 402 upon a predetermined event such as the passage of a set period of time, or upon a page unload, a form submit, or other user-initiated event. As described above, definition files and responses to user interactions can be changed dynamically, both during a particular user session and across different user sessions, for example, based on inferences drawn from the statistical information gathered from one or more sessions with the user.

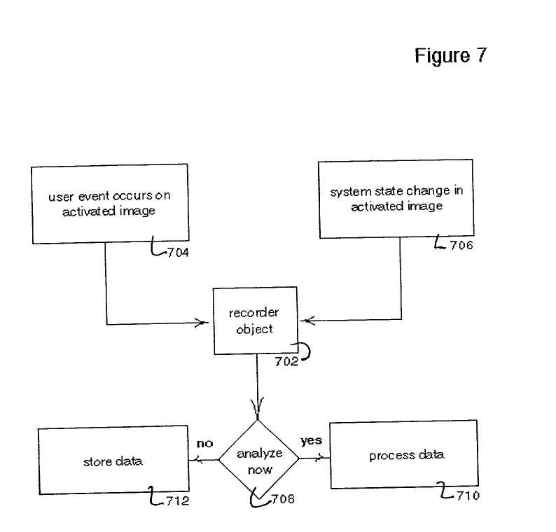

With reference now to FIGS. 5b and 6, the Web page 600 is displayed at step 520 at the client-side browser and is so constructed as to include the activated image within the real estate 601. In other words, the content provider 412 defines and supplies the HTML that governs the layout of the Web page 600 while the designated manager (e.g., the host system 402) defines and provides the definition file and template(s) 300 to activate any active regions in the image 200. The designated manager preferably stores the user's mouse movements and clicks at step 522 using a recorder object, described below in connection with FIG. 7. The user's movements are tracked at the client side, from time-to-time and in accordance with predetermined criteria, at step 524. A script or other routine continuously monitors whether the individual has interacted with any portion of the activated image, whether an active region or not, as shown at step 526, preferably while the individual's mouse movements continue to be tracked. When the individual interacts with one of the active regions, an associated event handler is invoked, as at step 528.

With brief reference to FIG. 6, a searchlight event handler has been invoked at step 528 in accordance with a particular feature of the present invention. FIG. 6 illustrates the Web page 600 displaying an image 200 as an activated image. A selector-driven cursor 602 can be positioned at a variety of positions on this Web page. As the cursor is moved about the Web page, it may pass over (“mouseover”) or be positioned outside of (“mouseout”) one or more active regions related to the image 200 through the template 300 (FIG. 3) and the definition file. The searchlight event handler responds to the event of the cursor being positioned within the boundaries of the image 200 and causes at least a portion of the template 300 to be superimposed on the image 200, in the foreground. The superimposed portion defines a searchlight 604, and is preferably updated as the cursor moves across the image 200 so that it continuously tracks the cursor movement in a fluid-like manner. When the cursor is positioned within a predetermined range of one of the active regions 302-308, the searchlight 604 identifies any selectable-links within that range, even when the cursor is positioned beyond the boundaries of the selectable-link itself or any selectable-link in the activated image. This differs substantially from conventional selectable-links which are either visually identified with text (e.g., “click here”) or animation, or which are automatically identified by conventional Web browsers only when the selector is positioned over the selectable-link, for example, by changing the cursor from an arrow into a hand, the appearance of alternative text when the cursor is over the link, by a change in the status bar, or a combination of these changes.

The searchlight preferably identifies the selectable-link by providing an indicium which distinguishes the selectable-link from the remainder of the image. The selectable-link is not displayed on the Web page of step 504 when the selector is beyond the predetermined range set for a particular selectable-link. With respect to placed products, the searchlight 604 feature assists individuals to locate any further information or purchase-form even when the selector (e.g., mouse) is not positioned directly over the active regions 302-308. In this manner, advertisers and sellers can respond to interested individuals at the point of presentation, and small, active regions are indicated at the client's browser so that the user can identify such regions. While the point of presentation may be an online catalog or merchant, it need not be; the point of presentation can instead be a photograph from a magazine which has been made interactive by the process of FIG. 1.

An object which permits a searchlight to flow with movements of the selector can be defined in Javascript as follows:

function searchLight(picturename, dleft, dtop, dright, dbottom){

var event_clientX;
var event_clientY;
event_clientX = myevent.pageX //find out where the mouse is
event_clientY = myevent.pageY
var mytop = document.layers[picturename].top; //find out where the picture is
var myleft = document.layers[picturename].left;
var top = event_clientY + dtop − myleft; //calculate the left, top, right, and bottom edges of the clipping

//rectangle

var left = event_clientX + dleft − myleft;
var right = event_clientX + dright − myleft;
var bottom = event_clientY + dbottom − mytop;

//modify picture to the new viewable “clip region”
and only clip to a region where the image exists.

document.layers[picturename].clip.top = (top < 0) ? 0 : top;
document.layers[picturename].clip.left = (left < 0) ? 0 : left;
document.layers[picturename].clip.right = (right < 0) ? 0 : right;
document.layers[picturename].clip.bottom = (bottom < 0) ? 0 : bottom;}

The above script operates as follows. The searchlight function detects the location of the user's mouse in relation to the template image to be clipped, and clips the template image a certain distance from the left, top, right, or bottom of that point (see variables dleft, dtop, dright, dbottom in the pseudocode above).

Referring back to FIG. 5b, at step 528, various event handlers can be invoked depending on the response that has been defined for the active region with which the individual has interacted. At step 530 the interactivity of the individual is examined to determine whether the person at the Web browser which is currently displaying the Web page 600 has selected more information on a product, that is, whether the individual has triggered the event handler for a placed product for which there is an advertisement. For example, by either passing over the active region 306 or selecting (e.g., by a mouse click) within that region, the individual can be provided with a display of further information on the shirt that the man in the image 200 is wearing. If the interactivity concerned the active region 306, then the appropriate ad would be presented in the active window at step 532. At step 534, the event is logged by tracking the individual's selector movements, clicks, and any requests for information that may have been made by the individual's Web browser to either the content provider's Web site or the host 402. These logged transactions later provide a basis for assessing fees to the merchants and/or source of products/services and for awarding a royalty to the content provider for hosting that placed-product advertising event, as indicated at step 536. The process flow then loops back to step 522 to record the event and track the individual's further mouse movements and test for any further interactivity. If the individual had not triggered the more information event, then the process flow proceeds to step 540 to attempt to discern different interactive-event types.

If the interactivity requires the display of an additional image, as determined at step 540, the additional image is displayed at step 542. Preferably, the additional images are pre-loaded and stored in memory or in a cached file so that no further loading is required in response to the interactivity of the individual with the Web page. Additional images can be displayed, for example, in response to the individual passing over or selecting within one of the active regions 302 and 304 which cause the display to be updated to now show a bar scene (active region 302 being the triggered event) or a dining room scene (when active region 304 is triggered). After displaying the additional image or information, the process flow loops to step 522 to record the event and track further movements and interactivity. If the individual had not triggered the additional image event, then the process flow proceeds to step 550.

At step 550, the interactivity is again examined to determine whether the individual has finished shopping and desires to checkout, that is, purchase any item selections that may have been made. If the individual has not finished shopping, a test is made to determine whether the individual wishes to make a purchase at step 560. If the individual desires to purchase the item for which the present event handler was invoked, purchase information such as quantity and size are gathered and the item is added to the shopping cart at step 562 and the process flow returns to step 522 as previously described. The purchase event is triggered by interacting with an active region which has its response defined as a purchase transaction, for example, the active region 308 (“buy dress”) in FIG. 3A and associated with FIG. 2. Otherwise, the active region event detected at step 526 was an instruction to load new content, as indicated at step 564, which causes the client side browser to display a new Web page or frame by looping back to step 520.

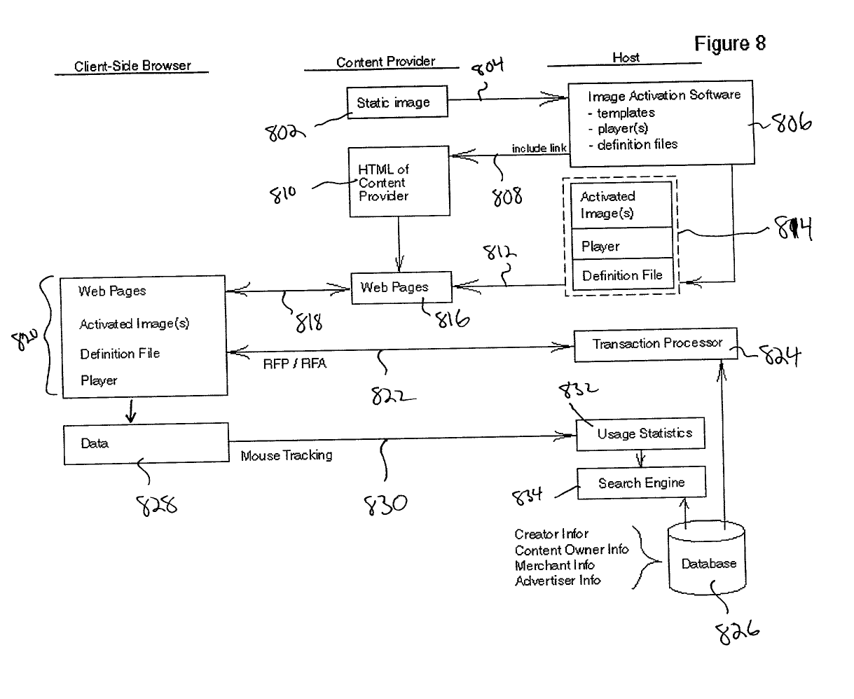

If the individual is ready to checkout, then all items that were purchased are tallied and a purchase event handler causes a form to pop-up at step 568 in which the individual provides various purchase transaction details such as credit card number or cybercash account, mailing and billing addresses, and the like. The information is required by the host 402 which handles the transaction using a host-provided back-end transaction processor 824 (see FIG. 8), but this processing is transparent to the user, the form instead being presented through the content provider's front end. The individual completes this request for purchase (“RFP”) form and submits (e.g., posts) it to the content provider 412 at step 570. The content provider, in turn, passes the RFP form to the host system 402 at step 572 along with other data which identifies the content provider for royalty payment and RFP tracking purposes. This can be done, for example, by posting that form or another form to the host system's server 402. As a result, the host server receives a request from a client-side browser in response to interaction with the activated image.

A back-end form processor at the host system 402 logs the RFP and forwards that form or another form to the merchant's server 406 over the Internet at step 574 or by some other communication link (e.g., fax as indicated by the phantom lines in FIG. 4). The third-party to whom a given request is forwarded is governed by the definition file, as previously established by the broker 162 just prior to the client loading the content provider's Web page. If the request concerns multiple interactive events (e.g., the customer's shopping cart includes several items), then the request is forwarded to one or more third-parties, as dictated by the definition file.

Because Web pages may be cached at the client side, it is possible that the request from a particular individual 410 may refer to a merchant or advertiser that is no longer a valid reference. The host 402 can prescribe a different merchant/advertiser to respond to the request, or provide other feedback to the user, by referencing the merchant and host databases 164, 166. The individual is provided with confirmation of the RFP at step 576, preferably in the form of a pop-up window overlaid upon the Web page of step 504 or perhaps in an e-mail. The confirmation at step 576 can come directly from the merchant's Web site, or the confirmation can be provided by the host system. The individual (now purchaser) can print or otherwise store the confirmation for later reference and close the confirmation window, if any. Thereafter, the process loops to step 522 for tracking the purchasers further mouse movements and clicks. At some time during the session with the individual, the host system receives tracking data and logs any ad requests that were made and recorded at step 524.

By including interactive product placements at the content provider or other Web site, a new business model results which is uniquely suited for the interactive environment made available by the Internet and other distributed computer networks. As indicated at step 580, the host system obtains fees from the merchants that are providing products and services to purchasers and also from the advertisers that make advertising information available to the individual. The fees can be structured in a variety of ways including monthly flat fees, per-transaction fees (e.g., on a when-clicked basis), and percentage-of-sale or follow-up sale basis. More generally, however, the third-party is charged for having different individuals' requests forwarded to them. Such fees result from the supplemental advertising market that results from placing products in otherwise static content and also from the new direct-sale market that has been enabled, both in accordance with aspects of this embodiment of the invention. The direct sale market differs from other e-commerce approaches in that the individual purchases a third party's goods or services without leaving the current Web page and, importantly, without loading the Web page of the third-party source. The same is true when advertisements pop-up for the placed ads. In either case, the functionality provided by the host system 402 is at the back-end of these interactive transactions, and so these charges are transparent to the individual/purchaser. On the other hand, the content provider has as its incentive at step 582 for hosting this new forum for commerce a royalty payment from the host system 402 for providing a forum which generates the individuals' requests for forwarding to third-parties. Preferably, the host nets revenue from each request in the amount of the difference between the amount charged to the third-parties and the amount credited to the content provider.

### EXAMPLE 1

A magazine has existing content in the form of a fashion spread for swim wear in which the swim suits from a variety of designers are illustrated. In the printed version of the magazine available for purchase at a news stand or mail delivery to subscribers, in order for the reader to purchase a particular swimsuit, he or she would have to contact the merchant or a store that carries the particular swim suit of interest. When presented as an electronic magazine, however, the same content can be presented as an activated image to instantly fulfill the shopping desires of the reader and permit that swim suit to be purchased in a variety of styles, colors and sizes.

### EXAMPLE 2

The fashion spread from the magazine of EXAMPLE 1, presented in an electronic form, includes swim suits from a variety of designers as well as sandals of other manufacturers. To purchase items of interest, the reader ordinarily contacts the merchants or stores that carry the brands of interest and makes purchases from them directly. By interacting with activated images in accordance with the present invention, however, the reader of the electronic magazine can instantly purchase a swim suit of one manufacturer and sandals from another manufacturer by interacting with the image at the magazine's Web site. The purchase transaction is forwarded to and handled by the merchant/vendor through the auspices of the magazine's Web site. The magazine therefore can provide this value added service to its readers without having to handle either the purchase transaction details or the merchandise. Moreover, the magazine publisher can receive a referral fee for directing the reader to the merchant as an incentive for providing active images in lieu of static content.

In the purchase transaction of EXAMPLE 2, the manufacturer of the selected wares is charged a fee for the lead, and the fee is collected by the designated manager, e.g., the host system 402 or its licensees. A portion of that fee accrues to the benefit of the publisher. Alternatively or in addition, the publisher may be assessed a separate fee for making the technology available at its Web site. In either case, however, the functionality provided by the designated manager occurs at the back-end of the purchase transaction so that the purchaser does not experience any disruptions or complications in the purchase transaction.

With reference now to FIG. 7, the movements and clicks of a user at the client-side that are recorded at step 522 and tracked at step 524 are handled by a recorder object 702. The recorder object causes a capture object to fill with data in response to events concerning activated images or other host-provided content. The events can be in response to a user event within the activated image (e.g., the recorder object is activated upon detecting a mouseover within the boundaries of the activated image), or in response to a system state-change event such as a scaling, scrolling, distortion, motion, or other morph of the activated image -regardless of whether there has been a change in the surrounding Web page. The recorder and capture objects are preferably defined by the image-activation player. The capture object holds information about such events. For example, if the event is a user-event , the coordinates of the selector and the name of the script that may have been invoked, if any, in response to the current selector position can be recorded, as shown at step 704. On the other hand, if the event is a state-change event, then various parameters concerning the state of the activated image (e.g., the left, top, width, height, clipleft, cliptop, clipwidth, and clipheight parameters) can be recorded, as shown at step 706. In either case, any change in the reactivity of the active image can be recorded (e.g., when a different template 300 is invoked due to the event), along with the name of the activated image that was being displayed (from which the identity of the content provider 412 can be discerned if not separately captured and recorded), and the date and time can be captured and recorded as well. At step 708, a decision is made whether to analyze the data gathered by the capture object now or later. If the analysis is to be done now, the data are analyzed at step 710. Otherwise, the data are stored for later analysis at step 712, either at the client-side or server side. The gathered data may be filtered or pre-processed to reduce the volume of the data. As will be understood by those versed in the art, the analysis can occur at the client-side machine or the data can be posted to a remote site for server-side analysis. Ultimately, the data is transferred to the host or designated manager.

FIG. 8 illustrates the flow of information between the host 402, the content provider 412, and an individual at a client-side station 410. Initially, the content provider provides static images 802 to the host, as indicated by the arrow 804. The host utilizes its image activation software 806 to create one or more templates and definition files which, when associated with the static images, activates the static images. In addition, the host provides either a standard player or a custom player which has been optimized to fit the needs of the content provider (for example, which only includes the functions and objects that are called for at that content provider's Web site. Thereafter, the host provides a link 808 for inclusion in the HTML content 810 of the content provider. The link references (see arrow 812) the activated image(s), definition file, and player as a package 814 for inclusion with the content provider's HTML content 810 into one more Web pages 816. When an individual references the Web pages of the content provider over a communication line 818, a platform-specific branch test is performed and the Web pages 816 are then rendered, dynamically. In other words, the link to the content provider's Web page causes the current definition file (as defined by the broker 162), player and activated-images to be combined with the HTML content of the content provider and then conveyed over the communication line 818 to the client-side browser.

The Web pages (or frames) loaded in the client-side browser include the activated images, a definition file, and an activated-image player as integrated content 820 into the client's operating system or Web browser. In the course of interacting with the activated image(s), the individual may make various requests for advertisements (“RFA”) and/or requests for purchases (“RFP”). These requests are indicated by the arrow 822 which conveys such requests from the client-side machine to a transaction processor 824 located at the host 402. As can be appreciated from FIG. 8, the RFPs and RFAs pass through the front-end of the content provider 412 to the host 402. These transactions are handled by the host, and processed by the merchants associated with or assigned to handle such requests. A database 826 informs the host of the merchant and/or advertiser data that is associated with or assigned to respond to the active region with which the user has interacted. Likewise, in the course of interacting with the activated image, the image-activation software or player records various data 828 which, from time to time, are conveyed to the host 402, as indicated by the arrow 830. Data from the player is stored as usage statistics 832 at the host, and a search engine 834 can be used to process the usage statistics, with regard to information concerning who created or owns the content for fee generation and market data purposes.

The foregoing system and method can be implemented, for example, using a commercially available browser that is Java, Javascript, VB Script, Flash, Macromedia, Shockwave, XML, Quicktime, or DHTML enabled which includes approximately 90% of all Web browsers. Those of skill in the art understand that the systems and methods of the present invention, when implemented in an object oriented language, need not follow the logical flow of the processes illustrated in FIGS. 1 and 5, but rather can be event-triggered; the flow diagrams are provided to illustrate in detail the functionality of the features of the present invention, and are not provided by way of limitation of the invention, which is defined only by the claims appended hereto and substantial equivalents thereof.

Glossary

The following definitions are intended to define the terms used herein, notwithstanding any other description hereinabove.

The term “activated image” refers to an image or other host-provided content which responds or flows with the actions of the user and includes a displayed image or other content from the host, at least one template in which active regions have been defined, and a definition file.

The term “browser” broadly refers to any software or device which can reference (address) a site on the Internet or other distributed computer network.

The term “content provider” is synonymous with “customer.” The term “customer” refers to a licensee or subscriber to the host system. An individual who seeks further information on a product or who makes a purchase at a Web site is not a “customer” as this term is used herein.

The term “individual,” when referring to a person, is a person who interacts with a placed product to obtain further information on that product.

The term “merchant” refers to a provider of goods or services. A merchant can be a customer, for example, when the merchant is a cataloger or publisher.

The term “mouseclick” refers to an event in which the mouse is positioned over a specific region of an image and one of its buttons is pressed. For example, a mouseclick event occurs when the user positions a cursor over a selectable-link and presses the mouse button. The mouseclick event can be handled by a Javascript routine, for example, using the “onmouseclick=functioncall( )” command, where functioncall defines the action to be taken to handle the mouseclick event. See mouseover.

The term “mouseout” refers to an event when the mouse is positioned beyond a specified region of an image and the mouseout event occurs when the user positions a cursor outside of the selectable region of a selectable-link.

The term “mouseover” refers to an event in which the mouse is positioned over a specific region of an image. For example, a mouseover event occurs when the user positions a cursor over a selectable-link. The mouseover event can be handled by a Javascript routine, for example, using the “onmouseover=functioncall( )” command, where functioncall defines the action to be taken to handle the mouseover event.

The term “placed product” refers to a product's appearance is a non-advertisement based photograph or other visual depiction which serves to promote or advertise that product. For example, when an actor in a Paramount® movie drinks Coca-Cola® but Coca-Cola® is not a producer or investor in the film. The appearance of the actor drinking Coca-Cola® is effectively an advertisement for Coca-Cola® whether or not the movie is itself an advertisement for Coca-Cola®.

The term “purchaser” refers to an individual who navigates the Internet or other network and interacts with a placed product to make a purchase from a Customer.

The term “selector” refers to an input device such as a mouse or trackball.

We claim:

1. A method for indicating a location of one or more selectable-links, comprising the step of indicating on a display the location of a selectable-link when a selector is positioned within a predetermined range outside of any selectable-link.

2. The method as in claim 1, wherein the indicated selectable-link is hidden from the display when the selector is positioned beyond the predetermined range of the selectable-link.

3. The method as in claim 1, wherein the indicating step comprises providing an indicium which distinguishes the selectable-link from the remainder of the image.

4. The method as in claim 1, wherein the selectable-link is positioned within a graphical image.

5. The method as in claim 1, including the additional step of maintaining the indication throughout the movement of the selector within the predetermined range.

6. A method for indicating a location of one or more elements of additional information associated with an image, comprising the step of indicating on a display the location of the additional information when a selector is positioned within a predetermined range outside of any active region.

7. The method as in claim 6, wherein the location of the additional information is hidden from the display when the selector is positioned beyond the predetermined range of the active region.

8. The method as in claim 6, wherein the indicating step comprises providing an indicium which distinguishes the active region from the remainder of the image.

9. The method as in claim 6, wherein the active region is positioned within a graphical image.

10. The method as in claim 9, wherein the additional information is a description of an item depicted in the graphical image.

11. The method as in claim 6, including the additional step of maintaining the indication throughout the movement of the selector within the predetermined range.

12. A method for interactively displaying information to a user, comprising the steps of:
a. displaying a first image on a display, the first image having one or more active regions associated therewith; and
b. obscuring a portion of the first image with the display of a second image fragment in response to a user's interaction with the active regions, the second image fragment being a different depiction of the obscured portion of first image and including information associated with the first image.

13. The method as in claim 12, wherein the different depiction in the second image fragment is related to the obscured portion of the first image.

14. The method as in claim 12, wherein the user's interaction comprises one of:
i. positioning a selector within a predetermined range of the active region;
ii. positioning the selector over the active region;
iii. positioning the selector within a predetermined range of the active region and selecting the active region from that position; and
iv. positioning the selector over the active region and selecting the active region.

15. The method as in claim 14, wherein the selector is one of a mouse, trackball, and a touch screen.

16. The method as in claim 12, wherein the first image is a frame in a sequence of temporally related images.

17. The method as in claim 16, wherein the temporarily related images comprise one of an MPEG movie clip, a Quicktime movie clip, and a multimedia flash movie picture.

18. A system for selectively indicating a location of one or more elements on a display of a terminal, comprising:
a. a cursor on the display, the cursor being repositionable by a user; and
b. a proximity detector operational within the terminal and responsive to the position of the cursor to selectively identify the location of the element only when the cursor is positioned within a predetermined region within and clear of the element.

19. The system as in claim 18, wherein the cursor is repositionable in response to movement of a selector which is communicatively coupled to the terminal.

20. The system as in claim 18, wherein the display has a touch-sensitive screen positioned thereover and wherein the cursor is repositionable in response to interaction by the user with the touch-sensitive screen.
